(19) United States
(12) Patent Application Publication
(10) Pub. No.: US 2011/0232588 A1
(43) Pub. Date: Sep. 29, 2011

(54) Integrated system for vapor generation and thin film deposition

(75) Inventors: Benjamin Y.H. Liu, North Oaks, MN (US); Yamin Ma, Roseville, MN (US); Thuc Dinh, Shakopee, MN (US)

(73) Assignee: MSP Corporation, Shoreview, MN (US)

(21) Appl. No.: 13/070,967

(22) Filed: Mar. 24, 2011

Related U.S. Application Data
(60) Provisional application No. 61/317,728, filed on Mar. 26, 2010.

(51) Int. Cl. F22D 5/26; F16K 31/02; F15D 1/00

(52) U.S. Cl. 122/451 R; 251/129.01; 137/561 R; 137/487.5; 137/1

(57) ABSTRACT

An apparatus and method for generating vapor from a liquid precursor for a thin film deposition on a substrate includes an inlet section in fluid communication with a downstream vaporization chamber section. The inlet section comprises a gas inlet for receiving gas from a gas source through a gas flow sensor and a gas flow control valve and a liquid inlet for receiving liquid from a liquid source through a liquid flow sensor and a liquid flow control valve. An electronic controller controls the gas and liquid flow control valves thereby controlling the rates of gas and liquid flow into the inlet section to generate vapor in the downstream vaporization chamber section for thin film deposition on the substrate.

### CROSS-REFERENCE TO RELATED APPLICATION

The present application is based on and claims the benefit of U.S. provisional patent application Ser. No. 61/317,728, filed Mar. 26, 2010, the content of which is hereby incorporated by reference in its entirety.

### FIELD

This disclosure relates to a method and an apparatus for generating vapor for thin film deposition on a substrate. The substrates of interest include a semiconductor wafer for fabricating integrated circuit devices such as microprocessors, memory chips, as well as digital and analog circuitry for signal processing, conditioning and/or data storage. The system is aimed at reducing the cost of the vapor generating apparatus while enhancing its performance and improving the productivity of the deposition process and the through-put of the deposition tool.

### BACKGROUND

Thin film deposition for semiconductor device fabrication is generally carried out with one or more liquid precursor chemicals. The liquid must be vaporized to form vapor in order to deposit thin films by a vapor phase process such as chemical vapor deposition, atomic layer deposition, plasma-enhanced chemical vapor deposition, and other processes. Ideally, the vapor can be generated on demand with little or no time delay. Limitation in the response time of the traditional vapor generating equipment has led to a slow buildup in vapor concentration and a delay in the startup of the deposition process. This delay in startup has led to wasted time, lost productivity and through-put of the deposition tool. While these losses have been accepted as necessary, their elimination can lead to a significant improvement in the efficiency and productivity of the manufacturing fab. One objective of this disclosure is to shorten the response time of the vapor generating equipment in order to increase the through-put of the film deposition tool.

Another aspect of the present disclosure is an integrated approach to system design to simplify the vapor generation systems so that the resulting apparatus is simpler, smaller and the manufacturing cost is lower while the system performance is enhanced.

### SUMMARY

This disclosure describes an apparatus for generating vapor from a liquid precursor for thin film deposition on a substrate. The apparatus includes an inlet section in fluid communication with a heated downstream vaporization chamber. The inlet section comprises a gas inlet for receiving gas from a gas source through a gas flow sensor and a gas flow control valve and a liquid inlet for receiving liquid from a liquid source through a liquid flow sensor and a liquid flow control valve. An electronic controller controls the gas and liquid flow control valve thereby controlling the rate of gas and liquid flow into the inlet section to generate vapor in the heated downstream vaporization chamber section for thin film deposition on a substrate.

This disclosure also describes an apparatus for generating vapor from a liquid precursor for thin film deposition on a substrate wherein the apparatus includes an inlet section in fluid communication with a heated vaporization chamber section located downstream. The inlet section has a gas inlet for receiving gas from the gas source through a gas flow sensor, a liquid inlet for receiving liquid form a liquid source through a liquid flow sensor, the liquid flow sensor having a response time of no more than 250 milliseconds, and mechanisms to control the rate of gas and liquid flow through the sensors to generate vapor for thin film deposition on the substrate.

This disclosure also describes an apparatus for generating vapor from a liquid precursor for thin film deposition on a substrate. The apparatus comprises an atomizer with a gas inlet for receiving gas from the gas source through a gas flow sensor and a gas flow control valve, and a liquid inlet for receiving liquid from a liquid source through a liquid flow sensor and a liquid flow control valve, and an orifice to increase the gas velocity to atomize the liquid flowing through the liquid inlet to form droplets. A heated vaporization chamber heats the gas and vaporizes the liquid droplets to form a vapor. The liquid flow control valve is separated from the liquid flow sensor by a length of connecting tubing to allow the liquid flow control valve to be located in close proximity to the gas inlet of the atomizer thereby controlling the rates of gas and liquid flow into the atomizer to generate vapor for thin film deposition on the substrate.

This disclosure also describes a multi-channel gas flow controller having a plurality of gas flow channels. The controller comprises a metal block with internal gas flow passageways and inlet and outlet ports for the gas to flow through. Each gas flow channel is provided with an orifice, a pressure sensor and a flow control valve. A multi-channel electronic controller for controlling the rate of gas flow through each gas flow channel provides a signal to the gas flow control valve in response to an outlet signal from the pressure sensor.

This disclosure also describes a method of controlling the rate of gas and liquid flow into a vaporization apparatus wherein the apparatus includes an atomizer and a vaporization chamber. The rate of gas flow is measured by a gas flow sensor and controlled by a gas flow control valve, the rate of liquid flow being measured by a liquid flow sensor and controlled by a liquid flow control valve. The rates of gas and liquid flows are controlled by an electronic controller to control the gas and liquid flow rate to gas and liquid flow rate set point values.

This disclosure also includes a method for multi-channel gas flow control of an apparatus comprising at least two flow channels. The method includes sensing the gas pressure upstream of an orifice in each flow channel, and controlling the rate of gas flow in each flow channel by an electronic controller that controls the rate of gas flow through each flow channel in response to the gas pressure upstream of the orifice.

### BRIEF DESCRIPTION OF THE DRAWINGS

FIG. 1 is a schematic diagram of the integrated vapor generation system for thin film deposition on a substrate

FIG. 2 shows the measured response of a commercially available Coriolis-Force liquid flow controller (A), a thermal mass flow control (B) and an experimental flow control system using a glass-tube liquid flow sensor for increased response speed (C)

FIG. 3 is a schematic diagram of an integrated multi-channel gas flow controller of this disclosure

### DETAILED DESCRIPTION OF THE INVENTION

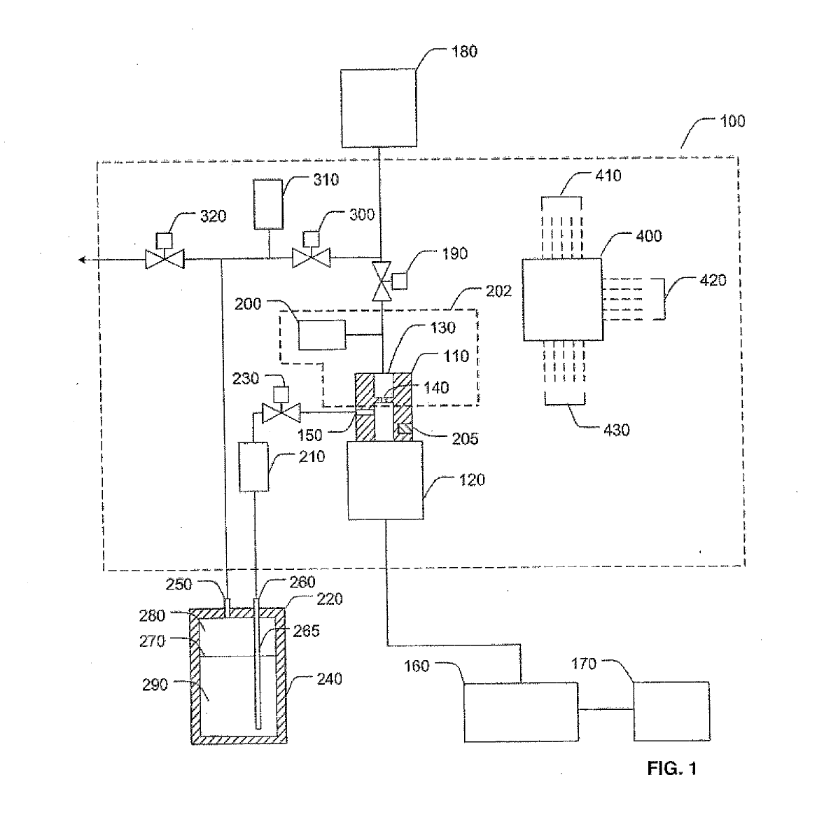

FIG. 1 is a schematic diagram of an integrated vapor generation and delivery system in one embodiment. The major system components are shown within the dotted rectangular area located generally at 100. It includes an atomizer 110 mounted on a vaporization chamber, 120, or connected to it through a short-length of connecting tubing. The atomizer has an inlet 130 for a compressed gas to enter, an atomizing orifice, 140, for the gas to flow through to form a high velocity gas jet to atomize the liquid flowing through liquid inlet 150 to form a droplet spray. The term orifice is used in its generic sense in this disclosure as a flow restriction, whether or not it is in the form of an orifice, a nozzle, a Venturi, or a flow constriction of some other cross-sectional shape. The droplet spray is comprised of the atomized liquid droplets suspended in the gas. The spray is directed to flow into the heated vaporization chamber 120 to heat the gas and vaporize the droplets. Heating is accomplished by an electric heater and the chamber temperature is regulated with the aid of a temperature sensor and a heater controller (not shown). The resulting gas/vapor mixture then flows into the deposition chamber, 160, for thin film deposition on a substrate. Deposition chamber 160 is connected to a source of vacuum 170 to create the proper vacuum for thin film deposition.

The compressed gas for atomizing the liquid to form droplets for vaporization comes from a compressed gas source 180. The gas is delivered to atomizer 110 at the desired rate of flow through a gas flow control system comprised of a gas flow sensor 202, and a flow control valve, 190. In the embodiment shown in FIG. 1, the flow sensor 202 is comprised of the atomizing orifice 140, and pressure sensor 200 located upstream of orifice 140 to sensing the upstream gas pressure. For a specific rate of gas flow through the atomizing orifice 140, the upstream gas pressure is a function of the gas flow rate. The output of pressure sensor 200 can be used to measure the rate of gas flow through the orifice. By means of control valve 190 the rate of gas flow can be adjusted or regulated to a specific set-point value corresponding to the set-point gas flow rate desired.

To achieve a high degree of accuracy in the measured rate of gas flow, it is desired that the gas flow through orifice 140 be equal to or higher than the critical pressure needed to maintain a sonic gas flow velocity in the orifice. When the gas flow in the orifice becomes sonic, the mass rate of flow through the orifice becomes independent of the downstream gas pressure, the flow rate being proportional to the absolute pressure of the gas upstream. This pressure is sensed by pressure sensor 200. A temperature sensor, 205, is placed in close thermal contact with the atomizer 110 to measure the temperature of the atomizer and the gas flowing there-through. Knowing the temperature the measured rate of gas flow can then be converted to standard mass flow rate units such as standard liter per minute (slm), or standard cubic centimeter per minute (seem). The standard conditions for mass flow measurement are typically zero degree Celsius in temperature and one atmosphere in gas pressure.

When the rate of gas flow through orifice 140 is below the critical value, i.e. below the value needed to maintain sonic flow through the orifice, the mass flow rate depends both on the upstream gas pressure as well as the pressure downstream. In which case an additional absolute pressure sensor or a differential pressure sensor (both not shown) may be added for accurate mass flow determination.

The above approach to gas flow sensing and measurement based on measuring the pressure created by a gas flow rate through an orifice is but one of several approaches that can be used. Another approach is to use a thermal mass flow sensor in which the convective cooling effect over a heated section of the tube is use for flow sensing. Thermal mass flow sensors (U.S. Pat. Nos. 4,815,280, 4,977,916, 5,398,549, 5,792,592, 6,813,944, and 7,469,583) for gas flow measurement are among the most widely used sensors for gas flow sensing and control in semiconductor thin film deposition applications.

Yet another approach to gas flow sensing is the Coriolis-force sensor (U.S. Pat. Nos. 6,513,392, and 6,526,839), in which a U-shaped metal tube is driven to vibrate at its natural oscillating frequency. When a gas flows through the vibrating U-tube at a specific mass rate of flow, a torque will develop causing the vibrating U-tube to become twisted. The degree of twist is then measured optically or by means of an electro-mechanical sensor to provide a signal for mass flow. Unlike the thermal mass flow sensor which senses the mass flow by means of the thermal effect produced by a flowing gas stream, the Coriolis-force sensor responds directly to the mass flow rate, thereby making mass flow measurement easier and potentially more accurate.

Any of the approaches described above to flow sensing, in principle, can be used in the integrated vapor generation and delivery system described in this disclosure, with factors such as accuracy, reliability, and cost being the most important.

The valve for controlling the rate of gas flow through the system, i.e. valve 190, can be a conventional solenoid valve, or a piezoelectric valve. The former uses an electric solenoid to vary the flow restriction to control the rate of gas flow, whereas the latter uses a piezoelectric actuator to produce the needed valve movement for gas flow control. The use of a solenoid valve or a piezoelectric valve for flow adjustment and/or control is well known to those skilled in the art of flow adjustment and control by electro-mechanical means and will not be further discussed.

The integrated system of FIG. 1 for vapor generation and delivery also includes a liquid flow sensor, 210, which provides an electrical output in response to the rate of liquid flow through the sensor. Sensor 210 is connected to a pressurized liquid source, shown generally located at 220, and to liquid flow control valve 230, which in turn is connected to the liquid inlet 150 on atomizer 110. For clarity, the liquid flow control valve 230 is shown connected to the atomizer liquid inlet through a short length of tubing. In practice, it is preferable that the valve be mounted directly on the atomizer to minimize the “liquid dead volume,” the volume of liquid residing in the liquid flow passageway downstream of the valve from the internal point of liquid shut-off when the valve is at its closed position to the point where the liquid flows out the liquid flow passageway into the atomizer inlet 150. A small liquid dead volume will increase the response speed of the vapor generation system and reduce its response time.

The manner in which the rate of liquid flow is adjusted and/or controlled is similar to that described in paragraphs [0012] and [0013] for gas flow adjustment and control. Like valve 190 for gas flow control, valve 230 for liquid flow control can also be a solenoid actuated valve or a piezo-electric valve using a piezoelectric actuator. For liquid flow control, a piezoelectric actuator is preferred because of its short response time and the higher accuracy in controlling the small mechanical movement needed for precise liquid flow control.

The same principles used for gas flow sensing and described in paragraphs [0012] and [0013] can also be used for sensing the rate of liquid flow in a tube. Thermal liquid flow sensors and Coriolis-force sensors are both available commercially and both have been used for liquid flow sensing and control for vapor generation in semiconductor device fabrication.

For liquid flow sensing in vapor-phase thin film deposition processes in semiconductor device fabrication, the sensor tube is typically made of metal, with stainless steel being the most common material used. This is the case both for the thermal and the Coriolis force sensors used for liquid flow sensing in semiconductor application.

One disadvantage of using a stainless steel tube sensor for liquid flow sensing is its relatively high density compared to other potentially more advantageous sensing tube material. A tube of a specific geometrical dimensions constructed of a high density material such as stainless steel will have a large mass compared to a tube constructed of a material with a lower density. The larger mass of a stainless steel tube will give rise to a high thermal inertia in the case of a thermal mass flow sensor, and a lower vibrating frequency in the case of a Coriolis-force sensor. The result is a slower response speed of the sensor. The response time of the available metal tube liquid flow sensors is typically 500 ms or more, with response time as long as several seconds being quite common for some commercially available thermal mass flow sensors.

To be acceptable for liquid flow sensing for vapor generation in thin film deposition, the material must be inert, i.e. does not react chemically with the precursor liquid to be vaporized. It must also be non-porous, so that reactive gases in the ambient atmosphere will not diffuse through the porous tube walls to react with the reactive liquid chemical precursors flowing inside. In addition, the material density of the tube should be low to reduce thermal and mechanical inertia and increase the sensor response speed. In the case of a thermal flow sensor, a material with a high thermal conductivity is desired for good heat conduction and increased sensitivity.

The density of stainless steel, which is an electrical conductor, is about 8.0 g/cm³. In comparison, the density in g/cm³ for some electrically insulating solids such as glass (2.4-2.8), quartz (2.65) and sapphire (˜6.5) are considerably lower. The thermal conductivity in units of Btu/hr-ft-F is 19 for stainless steel, 3.4-6.4 for quartz, and 19.7-20.2 for sapphire. Because of their lower densities, these insulating solids when used to fabricate a sensor tube for a thermal mass flow sensor or a Coriolis-force flow sensor will give rise to a shorter response time compared to that of stainless steel.

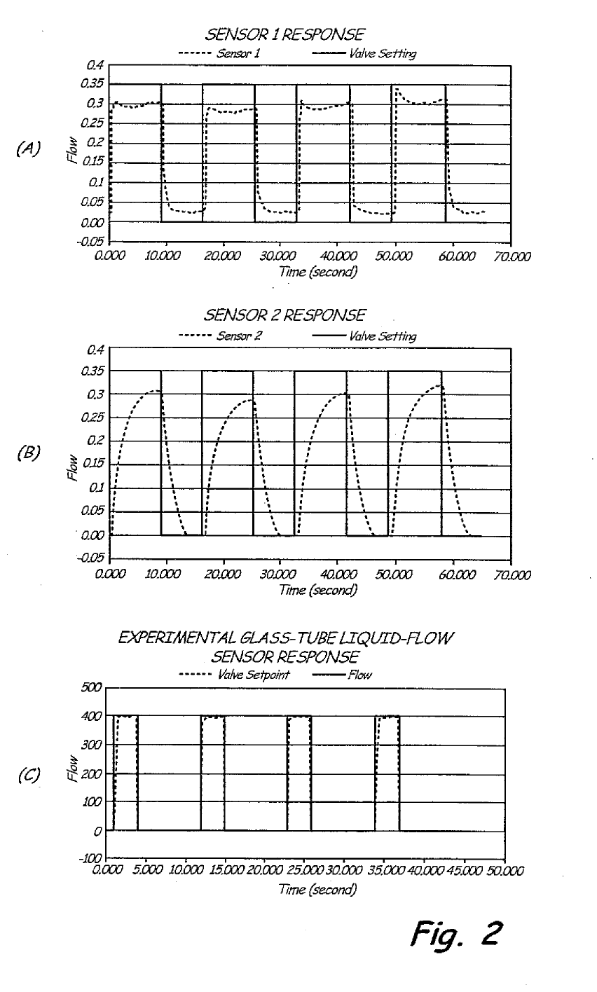

FIG. 2 compares the response time of an experimental glass-tube liquid sensor compared to two conventional stainless steel tube sensors. A response time less than 500 ms is easily achievable for the glass tube sensor. In the laboratory a sensor response as short as 10 ms has been measured with the glass-tube sensor.

While stainless steel is generally accepted for thin film deposition for semiconductor applications, precursor chemicals containing atomic species such as hafnium, zirconium, ruthenium, strontium, etc. are becoming increasingly more important in semiconductor integrated circuit device fabrication. Some of these newer precursor chemicals can react with trace metals in stainless steel, such as nickel. Nickel is widely used as a catalyst in industrial applications and is catalytically reactive with some modern precursor chemicals. It can lead to chemical reaction with the precursor liquid creating by-products that can clog the small liquid flow passageways in the sensor tubes. This is especially important for modern precursor chemicals containing atomic species with atomic numbers larger than that of rubidium (atomic number 37) or even those with atomic number larger than that of titanium (atomic number 22). For these applications, a sensor tube made of glass, quartz, or sapphire would be advantageous.

The integrated vapor generation system of FIG. 1 also includes a pressure controller for pressurizing the liquid source. The liquid source shown generally located at 220 provides the liquid precursor chemical needed for vaporization and thin film deposition. It includes a container 240, with an inlet, 250, for compressed gas to enter and an outlet, 260, for the pressurized liquid to flow out. Liquid is filled to level 270, so that space 280 above is filled with pressurized gas, which exerts the needed gas pressure on the liquid 290 below to cause the liquid to become pressurized. The compressed gas at the required pressure thus provides the motive force needed to cause the liquid to flow from source 220, through tube 265, liquid flow sensor 210, and control valve 230 and into the atomizer 110 where the liquid is atomized to generate vapor in the heated vaporization chamber 120.

The integrated vapor generation system of FIG. 1 also provides a gas with the required regulated gas pressure for the liquid source, 220. Pressure regulation is achieved by means of an on/off valve 300 and pressure sensor, 310. When pressure sensor 310 senses a pressure below the set-point value, valve 300 will open to allow the pressurized gas at the source pressure from gas source, 180, to flow into the liquid container, 240 to increase its pressure, the pressure of the compressed gas in source 180 being higher than the regulated gas pressure for liquid source 220. Upon reaching the desired set-point value, valve 300 will close. An auxiliary on/off valve, 320, referred to as a bleed valve, can be opened to allow the gas in container 240 to flow out, thereby reducing the gas pressure, if a lower pressure is needed in the pressurized liquid container 240.

The integrated vapor generation system of FIG. 1 also includes a vaporization system controller, 400, to provide the overall control for the system. Output signals from the pressure, temperature and flow sensors in the system are communicated to the vaporization system controller through input lines, 410. Set-point values for the controlled parameters are communicated from the controller for the film deposition tool through lines 420 on the vaporization system controller. Output signals from the vaporization system controller are communicated to the control valves for flow and pressure control through output lines, 430. Communication between the tool controller and the vaporization system controller 400 through lines 420 can be analog in nature, or digital using one of the standard digital communication protocols such as RS232, RS485, Ethernet, Devicenet, Modbus, etc.

The traditional approach to liquid flow control for vapor generation is to use a liquid flow controller, in which the liquid flow sensor 210 of FIG. 1 is combined with liquid flow control valve 230 to form a single integrated liquid flow controller unit with built-in electronic circuitry to sense the flow and control the rate of liquid flow (U.S. Pat. No. 4,977,916, D436876). In this traditional design the outlet of control valve 230 is connected by a length of tubing to the atomizer inlet 150. The integrated vapor generation system of FIG. 1 uses a liquid flow sensor 210 and a liquid flow control valve 230 as separate independent units, which can be connected by a length of connecting tubing in between so that the flow sensor and the liquid flow control valve can be located at the most appropriate position for each in order to achieve the best overall system performance.

For liquid flow control, the pressure of liquid source 220 is typically in the range between 1 to 4 atmospheres or approximately 760 to 3000 Torr. At the point where the liquid enters the atomizer at inlet 150, which is located downstream of the atomizing orifice, the liquid is exposed to a vacuum gas pressure, at which point the liquid pressure may be in the range between less 10 Ton to 100 Torr. A liquid in source 220 is in contact with a gas at high pressure. This high pressure gas will cause some gas to be absorbed into the liquid to form a dissolved gas solution. When this liquid solution flows through flow control valve 230 its pressure will drop by more than 300 fold in some cases. This sudden drop in liquid pressure will cause the dissolved gas to come out of the liquid solution and form gas bubbles. The bubbles can grow to a large size if the tubing connecting flow control valve 230 and inlet 150 on atomizer 100 is long. The flow of liquid into atomizer 110 will thus be interrupted periodically by gas bubbles formed in the liquid to cause the liquid flow into the atomizer to become unsteady, thereby causing vapor output from the vaporization system to fluctuate, leading to flow instability in the tool and non-uniform film thickness on the wafer.

The above problem of liquid flow fluctuation due to bubble formation in the liquid flow line can be greatly reduce or eliminated by locating the liquid flow control valve directly on the atomizer. Experiments in the laboratory have shown that by relocating the liquid flow control valve from the liquid flow controller in a traditional liquid flow control system to the new design of FIG. 1 where the control valve is separated from the flow sensor and mounted directly on the atomizer or connected to it by a short length of tubing can greatly reduce or eliminate entirely the fluctuating liquid flow caused by gas bubbles. In general, the shorter is the length of the liquid flow pathway between the liquid flow control valve and the atomizer gas inlet, the shorter will be the residence time of liquid in this passageway, and better the flow stability will be. To achieve the best performance, the length of tubing generally should be shorter than about 30 cm or having an internal volume of less than 500 microliters

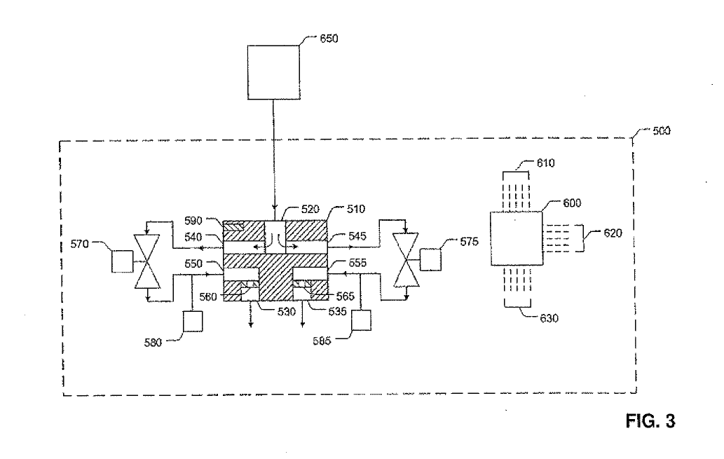

FIG. 3 is a schematic diagram of an integrated multi-channel gas flow control system to provide multi-channel gas flow control for use in thin film deposition. For clarity only two flow channels are shown. In principle, many more flow channels can be provided to meet the need of a specific application. In practice, a specific film deposition tool will need only a limited number of flow control channels and the number of flow channels provided in a given integrated multi-channel flow control system can be selected to meet the actual need of a single film deposition tool.

The integrated multi-channel flow control system is shown located at 500 in FIG. 3. In the schematic two-channel system shown in FIG. 3, a metal block, 510, is provided with inlet and outlet ports and internal gas flow passageways to direct the flow from a compressed gas source, 650, to flow into the metal block through inlet port 520, then through outlet ports, 540 and 545, into gas flow control valves 570 and 575 respectively. The gas flow control valves 570 and 575 are mounted on the sides of metal block 510 so that the gas, after passing through valves 570 and 575 will be returned to the metal block through ports 550 and 555. Upon re-entering entering the metal block, the two separate gas streams then flow through orifices 560 and 565 to create the gas pressure needed for flow sensing. Pressure sensors 580 and 585 then sense the respective gas pressure upstream of orifices 560 and 565 for sensing the rate of gas flow through the orifices. A temperature sensor 590 is placed in close thermal contact with metal block 510 to sense the temperature of the metal block and the temperature of the gas flowing there-through for accurate temperature compensation and mass flow measurements. Electronic controller 600 is provided with the necessary input lines 610 to receive the output signal from the pressure and temperature sensors as input signal to controller 600. Like the electronic controller 400 in FIG. 1, controller 600 is also provided with lines 420 for digital or analog communication with the tool controller, and output lines 430 for controlling the rate of gas flow through the respective gas flow control valves.

Controllers 400 and 600 are typically microprocessor-based electronic controllers with internal memories for program and data storage, circuitry to receive input signals in analog and digital forms, provide output signals to carry out various control function through electromechanical transducers, such as solenoid and piezoelectric actuated valves. A single micro-processed based controller can usually carry out a multitude of computation and control functions making the use of such microprocessor based controllers particularly advantageous for controlling the gas and liquid flow rates, and additional control functions such as gas pressure control, and temperature compensation for accurate gas flow measurement. The capability of microprocessor based controllers are well known to those skilled in the art of designing such control systems and will not be further discussed in this disclosure.

The above described approach to designing an integrated vapor generation and delivery system including the design of a multi-channel gas and liquid flow controller can lead to cost savings by eliminating redundant system components. A single controller can be used to control the myriads of controlled functions in vapor generation for thin film deposition in semiconductor device fabrication including control of flow of gas and liquid flowing into the same atomizer. The result is an overall system that is small and compact, with reduced cost of manufacturing and improved performance characteristics such as improved reliability and shortened response time.

The traditional approach to vaporization system design is to use separate gas and liquid flow controllers each with its own sensor, flow controller and an electronic controller, packaged into stand-alone systems. Each flow controller has its own flow control valve and flow sensor built into a common flow controller body that needs to be machined individually, then assembled with the electronic sensing and control circuitry for flow control. The integrated system approach of the present disclosure, in the case of the multi-channel gas flow control system, uses one single mechanical base to house the separate flow channels. An 8-channel system will thus have only one metal block for all eight channels, and one microprocessor based controller to control the flow for all eight flow channels, a single temperature sensor to sense the temperature for all eight channels, etc. The impact of such an approach is considerable in terms of size, cost saving, and improved performance characteristics.

In addition to cost saving, reduced physical size, the integrated system can also lead to improved reliability. In the traditional approach, when separate components are used each with its own controller, the components are connected by tubing connections which must be leak-proof and vacuum tight. The overall physical space occupied by the separate components and the connecting tubing and fittings is considerably larger compared to the integrated system described in this disclosure. The result is that the integrated system of this disclosure is smaller and occupies a smaller space. By eliminating unnecessary tubing connections, the system also becomes more reliable in terms potential leakage of ambient air into the vacuum system through small leakage crevasses in the fittings and tubing welds. The end result is a small compact system with a lower cost of manufacturing and higher reliability in performance.

Although the present invention has been described with reference to preferred embodiments, workers skilled in the art will recognize that changes may be made in form and detail without departing from the spirit and scope of the invention.

What is claimed is:

1. An apparatus for generating vapor from a liquid precursor for thin film deposition on a substrate including an inlet section in fluid communication with a heated downstream vaporization chamber section, the apparatus comprising:
said inlet section comprising a gas inlet for receiving gas from a gas source through a gas flow sensor and a gas flow control valve and a liquid inlet for receiving liquid from a liquid source through a liquid flow sensor and a liquid flow control valve; and
an electronic controller for controlling the gas and liquid flow control valves thereby controlling the rates of gas and liquid flow into said inlet section to generate vapor in said heated downstream vaporization chamber section for thin film deposition on the substrate.

2. The apparatus of claim 1 said gas flow sensor comprises a thermal mass flow sensor or a Coriolis-force mass flow sensor.

3. The apparatus of claim 1 including a gas flow sensor comprised of an orifice in said inlet section for the gas to flow through causing the gas pressure upstream of said orifice to increase and a pressure sensor to sense the resulting gas pressure upstream of said orifice.

4. The apparatus of claim 3 including a temperature sensor to sense the gas temperature for temperature compensation and mass flow determination.

5. The apparatus of claim 1 said liquid flow sensor comprising a thermal mass flow sensor or a Coriolis-force mass flow sensor.

6. The apparatus of claim 1 said liquid flow sensor comprising a thermal mass flow sensor with a stainless steel sensing tube.

7. The apparatus of claim 1 said liquid flow sensor comprising a thermal mass flow sensor with a sensing tube made of a non-porous, electrically insulating material.

8. The apparatus of claim 7 said material comprising glass, quartz or sapphire.

9. The apparatus of claim 1 and farther comprising a pressure controller for controlling the gas pressure in said liquid source.

10. The apparatus of claim 3, said orifice being capable of atomizing the liquid flowing into said liquid inlet to form droplets when gas flows through said orifice.

11. The apparatus of claim 3, said orifice be capable of causing upstream gas pressure to be at least equal to the critical gas pressure for creating sonic gas flow in said orifice.

12. An apparatus for generating vapor from a liquid precursor for thin film deposition on a substrate including an inlet section in fluid communication with a heated vaporization chamber section located downstream, the apparatus comprising:
said inlet section having a gas inlet for receiving gas from a gas source through a gas flow sensor; a liquid inlet for receiving liquid from a liquid source through a liquid flow sensor;
said liquid flow sensor having a response time of less than about 250 milliseconds; and
mechanisms to control the rates of gas and liquid flow through said sensors to generate vapor for thin film deposition on a substrate.

13. The apparatus of claim 12 said liquid flow sensor comprising a thermal mass flow sensor with a sensing tube made of glass quartz or sapphire.

14. The apparatus of claim 13 said liquid being sensed is a precursor liquid containing an atomic species with an atomic number of at least about 22.

15. An apparatus for generating vapor from a liquid precursor for thin film deposition on a substrate, the apparatus comprising:
an atomizer with a gas inlet for receiving gas from a gas source through a gas flow sensor and a gas flow control valve and a liquid inlet for receiving liquid from a liquid source through a liquid flow sensor and a liquid flow control valve and an orifice to increase the gas velocity to atomize the liquid flowing through said liquid inlet to form droplets;
a heated vaporization chamber to heat the gas and vaporize the liquid droplets to form vapor; and
said liquid flow control valve being separated from said liquid flow sensor by a length of connecting tubing and located downstream of said liquid flow sensor for controlling the rates of gas and liquid flow into said atomizer to generate vapor for thin film deposition on the substrate.

16. The apparatus of claim 15 said liquid control valve being (a) mounted directly on the atomizer with no connecting tubing in between, or (b) connected to said gas inlet by a length of tubing shorter than about 30 cm or having an internal volume of less than about 500 microliters.

17. The apparatus of claim 15, said liquid flow control valve comprising a solenoid valve or a valve with a piezoelectric actuator.

18. A multi-channel gas flow controller having a plurality of gas flow channels, the controller comprising a metal block with internal gas flow passageways and inlet and outlet ports for the gas to flow through each gas flow channel being provided with an orifice, a pressure sensor and a flow control valve; and a multi-channel electronic controller for controlling the rate of gas flow through each gas flow channel by providing a signal to the gas flow control valve in response to an output signal from said pressure sensor.

19. The apparatus of claim 18 including a temperature sensor for sensing gas temperature to compensate for the effect of temperature on a measured mass rate of gas flow.

20. The apparatus of claim 18 for providing gas flow control of at least two gas flow channels.

21. A method of controlling the rate of gas and liquid flow into a vaporization apparatus including an atomizer and a vaporization chamber, said rate of gas flow being measured by a gas flow sensor and controlled by a gas flow control valve, said rate of liquid flow being measured by a liquid flow sensor and controlled by a liquid flow control valve, said rates of gas and liquid flows being controlled by an electronic controller to control said gas and liquid flow rates to gas and liquid flow rate set point values.

22. A method for multi-channel gas flow control of an apparatus comprising at least two flow channels, including sensing gas pressure upstream of an orifice in each flow channel, and controlling the rate of gas flow in each flow channel by an electronic controller to control the rate of gas flow through each flow channel in response to the gas pressure upstream of said orifice.

23. The method of claim 21 including additionally measuring the temperature of said gas to provide temperature compensation for measuring the gas flow in mass flow units.
